(19) United States
(12) Patent Application Publication
(10) Pub. No.: US 2016/0195849 A1
(43) Pub. Date: Jul. 7, 2016

(54) FACILITATING INTERACTIVE FLOATING VIRTUAL REPRESENTATIONS OF IMAGES AT COMPUTING DEVICES

(71) Applicant: INTEL CORPORATION, Santa Clara, CA (US)

(72) Inventors: Akihiro Takagi, San Mateo, CA (US); Jonathan C. Moisant-Thompson, Santa Clara, CA (US); Anders Grunnet-Jepsen, San Jose, CA (US)

(73) Assignee: INTEL CORPORATION, Santa Clara, CA (US)

(21) Appl. No.: 14/747,697

(22) Filed: Jun. 23, 2015

Related U.S. Application Data
(60) Provisional application No. 62/099,857, filed on Jan. 5, 2015.

(51) Int. Cl. G03H 1/04; G03H 1/02; G03H 1/22; G03H 1/08

(52) U.S. Cl. CPC G03H 1/0486; G03H 1/0406; G03H 1/0891; G03H 1/0248; G03H 1/2202; G03H 1/2249; G03H 2001/0216; G03H 2001/0232; G03H 2001/2281

(57) ABSTRACT

A mechanism is described for facilitating interactive floating virtual representations of images at computing devices according to one embodiment. A method of embodiments, as described herein, includes receiving a request for a virtual representation of an image of a plurality of images, where the virtual representation includes a three-dimensional (3D) virtual representation that is capable of being floated in mid-air. The method may further include selecting the image to be presented via an image source located at a first angle from an imaging plate, and predicting a floating plane to be located at a second angle from the imaging plate, where the image is communicated from the image source to the floating plane via the imaging plate. The method may further include presenting the virtual representation of the image via the floating plane.

### CLAIM OF PRIORITY

This application claims the benefit of and priority to U.S. Provisional Patent Application No. 62/099,857, Attorney Docket No. 42P78524Z, entitled FACILITATING INTERACTIVE FLOATING DISPLAYS, by Akihiro Takagi, et al., filed Jan. 5, 2015, the entire contents of which are incorporated herein by reference.

### FIELD

Embodiments described herein generally relate to computers. More particularly, embodiments relate to facilitating interactive floating virtual representations of images at computing devices.

### BACKGROUND

Many attempts have been made to achieve holographic-like images, but such attempts have failed in that due to their various limitations, they have fallen short of achieving the necessary requirements for widespread adoption by users. For example, conventional techniques have been unsuccessful in achieving the acceptable levels in any number of areas, such as cost, power consumption, brightness level, color reproduction, resolution, bandwidth, etc.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a virtual and interactive floating display mechanism according to one embodiment.

FIG. 2 illustrates a virtual and interactive floating display mechanism according to one embodiment.

FIG. 3A illustrates an architectural setup of a computing device according to one embodiment.

FIG. 3B illustrates an architectural setup of a computing device according to one embodiment.

FIG. 3C illustrates an architectural setup of a computing device according to one embodiment.

FIG. 3D illustrates an architectural setup of a computing device according to one embodiment.

FIG. 3E illustrates an architectural setup of a computing device according to one embodiment.

FIG. 3F illustrates an architectural setup of a computing device according to one embodiment.

FIG. 3G illustrates an architectural setup of a computing device according to one embodiment.

FIG. 3H illustrates an architectural setup of a computing device according to one embodiment.

FIG. 4A illustrates a transaction sequence for facilitating floating interactive virtual representations of images according to one embodiment.

FIG. 4B illustrates a method for facilitating floating interactive virtual representations of images according to one embodiment.

FIG. 5 illustrates computer system suitable for implementing embodiments of the present disclosure according to one embodiment.

FIG. 6 illustrates computer environment suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel user interface for offering floating displays or virtual interpretations using depth sensing. Embodiments provide for an end-to-end three-dimensional (3D) solution for allowing the user to interact with virtual representations of objects or images floating in space without having to require special glasses for viewing or gloves for interacting. For example and in one embodiment, a depth sensing camera (such as by Intel®), may be used for obtaining sensory data inputs along with one or more imaging plates, such as Asukanet imaging plates, for outputting real image floating displays, as will be further described throughout this document. Further, for example and in one embodiment, self-alignment for accepting various users' varying physical attributes (e.g., height, seating height, view point, arm length, etc.) may be achieved through intelligent self-alignment and calibration, where other optical elements or components may be used to make a thinner and lighter product form factor.

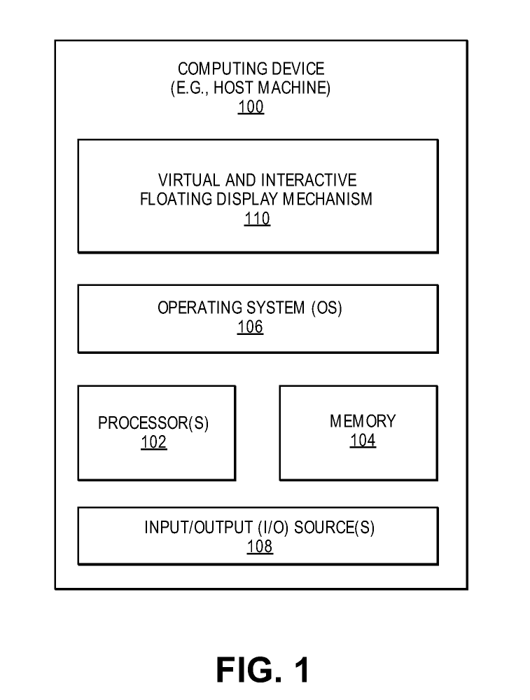

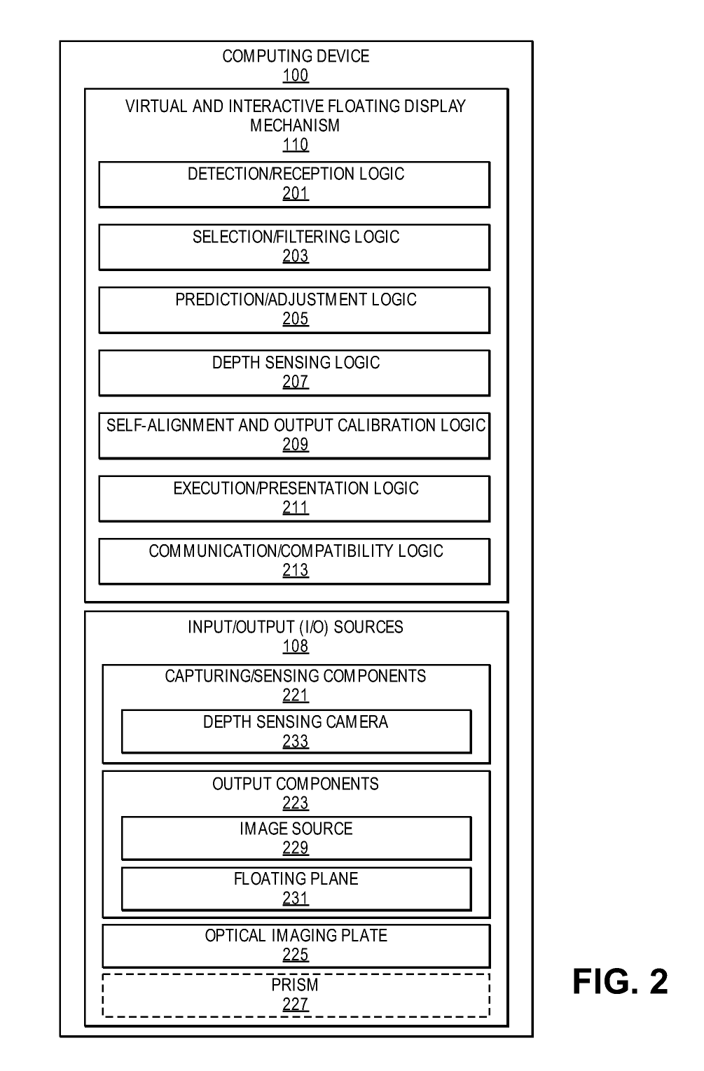

FIG. 1 illustrates a computing device 100 employing a virtual and interactive floating display mechanism 110 according to one embodiment. Computing device 100 serves as a host machine for hosting virtual and interactive floating display mechanism (“floating mechanism”) 110 that includes any number and type of components, as illustrated in FIG. 2, to facilitate virtual representations of images, the virtual representations are interactive and capable of floating in mid-air as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, head-mounted binoculars, gaming displays, military headwear, etc.), and other wearable devices (e.g., smart watches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates a virtual and interactive floating display mechanism 110 according to one embodiment. In one embodiment, floating mechanism 110 may include any number and type of components, such as (without limitation): detection/reception logic 201; selection/filtering logic 203; prediction/adjustment logic 205; depth sensing logic 207; self-alignment and output calibration logic 209; execution/presentation logic 211; and communication/compatibility logic 213.

Computing device 100 may further include I/O sources 108 of FIG. 1 having any number and type of capturing/sensing components 221 (e.g., depth sensing cameras (e.g., depth sensing camera 233), two-dimensional (2D) cameras, 3D cameras, image sources, sensors, detectors microphones, etc.) and output components 223 (e.g., image source 229 (e.g., standard liquid-crystal-display (LCD) screen), floating plane 231, display screens/devices, projectors, display/projection areas, speakers, etc.). Computing device 100 may further include optical imaging plate (“imaging plate”) 225 (e.g., Asukanet imaging plate, Asukanet Areal Imaging Plate, etc.) and one or more other components that may be optional and employed as desired or necessitated, such as prism 227, etc.

Computing device 100 may be in communication, over one or more networks or communication channels, with one or more repositories, data sources, database, etc., to store and maintain any amount and type of data (e.g., real-time data, historical contents, metadata, resources, policies, criteria, rules and regulations, upgrades, etc.). Similarly, computing device 100 may be in communication with any number and type of other computing devices over one or more networks (e.g., communication medium), such as Cloud network, Internet, intranet, Internet of Things (“IoT”), proximity network, Bluetooth, etc.

Capturing/sensing components 221 may include any number and type of capturing/sensing devices, such as one or more sending and/or capturing devices, such as cameras (e.g., 2D cameras, 3D cameras, depth sensing cameras, such as depth sensing camera 233, etc.), microphones, vibration components, tactile components, conductance elements, biometric sensors, chemical detectors, signal detectors, electroencephalography, functional near-infrared spectroscopy, wave detectors, force sensors (e.g., accelerometers), illuminators, etc.) that may be used for capturing any amount and type of visual data, such as images (e.g., photos, videos, movies, audio/video streams, etc.), and non-visual data, such as audio streams (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing components 221 may further include one or more of supporting or supplemental devices for capturing and/or sensing of data, such as illuminators (e.g., infrared (IR) illuminator), light fixtures, generators, sound blockers, etc.

It is further contemplated that in one embodiment, capturing/sensing components 221 may further include any number and type of sensing devices or sensors (e.g., linear accelerometer) for sensing or detecting any number and type of contexts (e.g., estimating horizon, linear acceleration, etc., relating to a mobile computing device, etc.). For example, capturing/sensing components 221 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

For example, capturing/sensing components 221 may further include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components 221 may further include voice recognition devices, photo recognition devices, facial and other body recognition components, voice-to-text conversion components, etc.

Computing device 100 may further include one or more output components 223 in communication with one or more capturing/sensing components 221 and one or more components of floating mechanism 110 to facilitate displaying of 2D and/or 3D virtual interactive representations floating in mid-air, playing or visualization of sounds, displaying visualization of fingerprints, presenting visualization of touch, smell, and/or other sense-related experiences, etc. For example, output components 223 may further include one or more display or telepresence projectors to project a real image's virtual representation that is capable of floating in the air while being interactive and having the depth of a real-life object.

Further, output components 223 may include tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output components 223 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

In one embodiment, detection/reception logic 201 may be used to perform tasks involving detection and/or reception of any number and type of requests, data, etc. For example, a user's request to choose an image from any number and type of images to be virtually represented such that they may be floated and interacted with the user, according to one embodiment, may be initially received at or detected by detection/reception logic 201. Once the user request is received at detection/reception logic 201, subsequent processes may be triggered by one or more components of floating mechanism 110.

For example and in one embodiment, once the user request regarding an image (e.g., musical keyboard, book, game character, human face, etc.) is received at detection/reception logic 201, selection/filtering logic 203 may be used to select the image requested by the user from any number and type of images. For example, the user may place a request for choosing an image corresponding to a real object, such as an image of a musical keyboard, from a variety of images corresponding to a variety of objects, for virtual representation, wherein this request may then be received at detection/reception logic 201 and then forwarded on to be processed by selection/filtering logic 203 which, for example, filters through all the variety of images to select the requested image. In one embodiment, once the requested image is selected or filtered by selection/filtering logic 203, it may be offered or displayed using image source 229 (e.g., LCD screen) of output components 223.

In one embodiment, the angle, such as a glass angle, between image source 229 and imaging plate 227 may be known or predefined and using this information, prediction/adjustment logic 205 may predict a reflected location of floating plane 231 where the selected image may be virtually represented. For example and in one embodiment, as illustrated with reference to FIG. 311, a first angle, such as glass angle, between image source 229 and imaging plate 227 may be the same as a second angle, such as floating angle, between imaging plate 227 and floating plane 231 and therefore, the glass angle may be used to predict the floating angle as facilitated by prediction/adjustment logic 205.

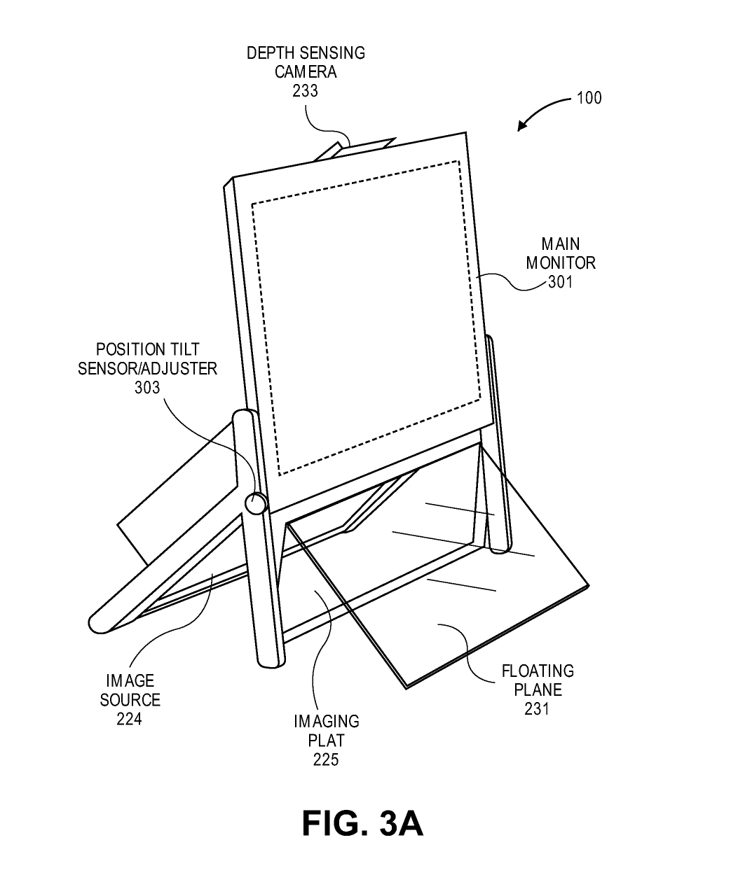

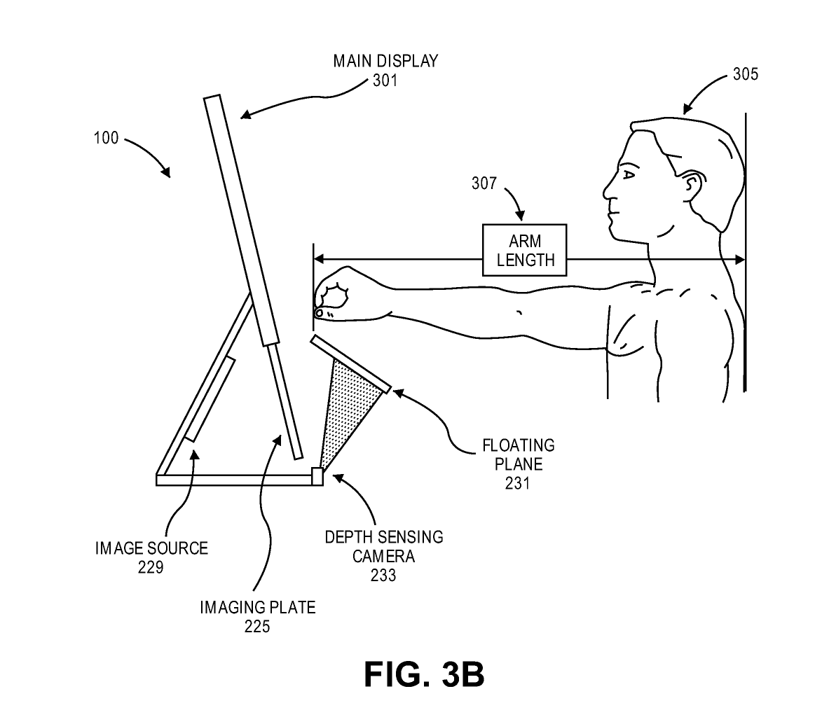

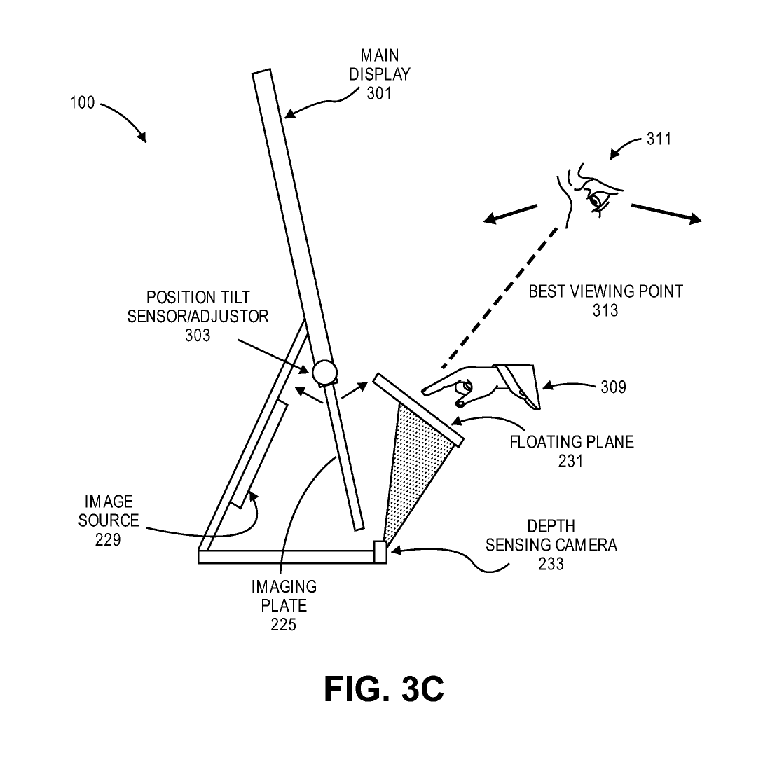

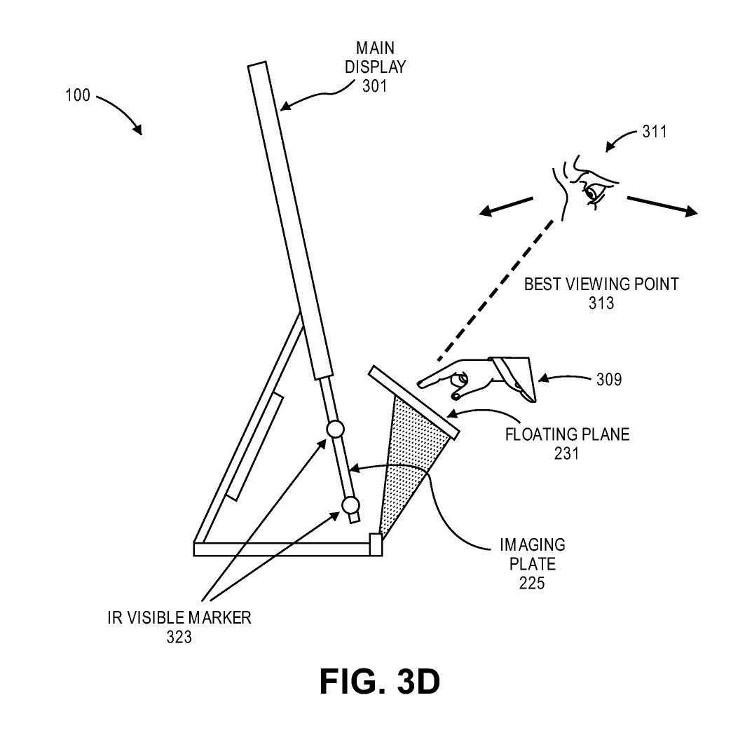

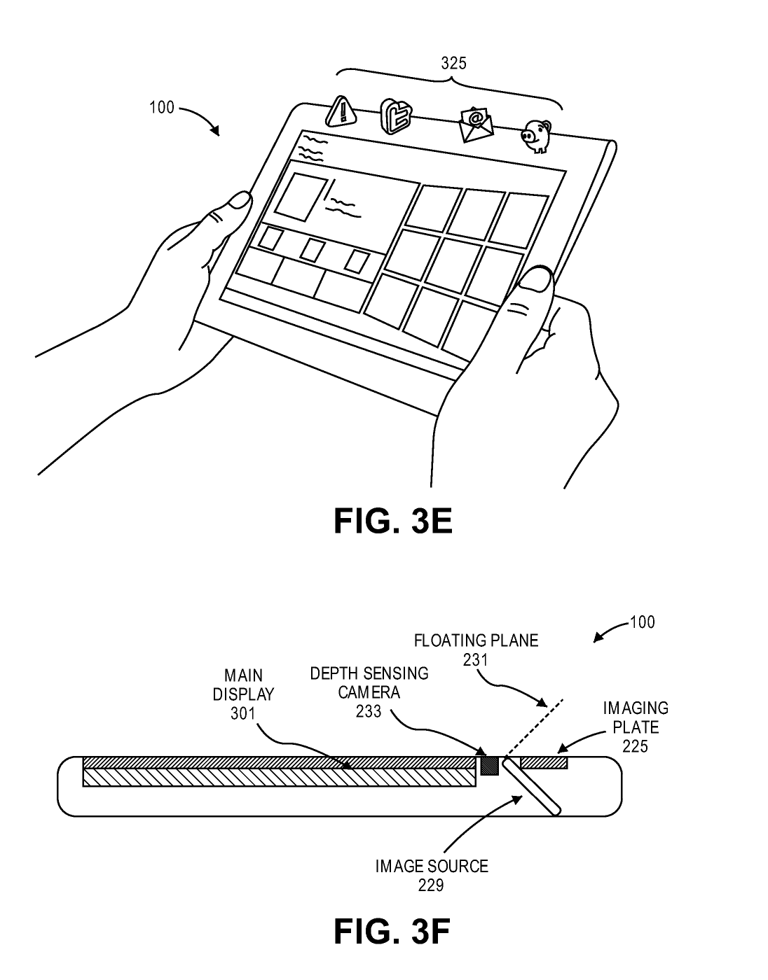

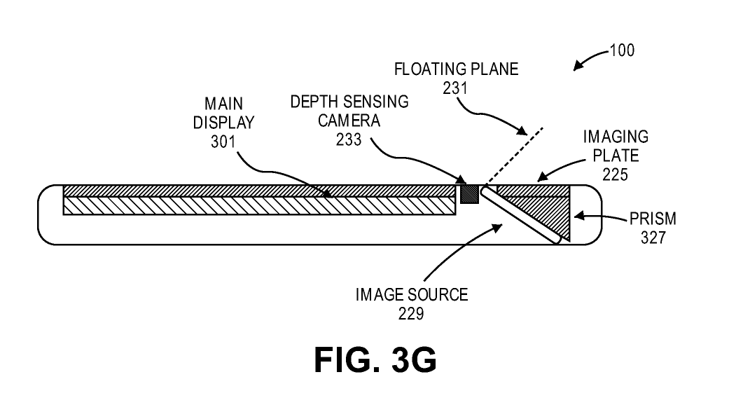

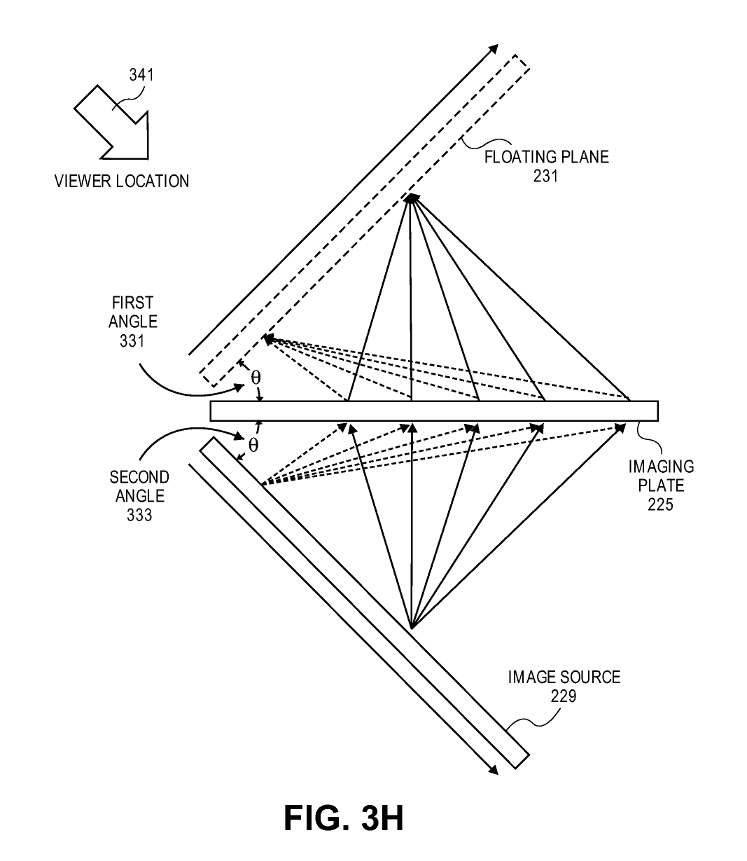

Further, in light of imaging plate principles, a viewing zone may be limited to a predefined degree of angle, such as +−15 degrees, from the user's best viewing point considering each user's varying physical attributes (e.g., height, seating height, view point, arm length, etc.). For example and in one embodiment, as illustrated with reference to FIG. 3C, computing device 100 (e.g., all-in-one personal computer (PC), etc.) may have an imaging plate adjustment mechanism, as facilitated by prediction/adjustment logic 205, to be used for prediction and adjustment of imaging plate 227 with respect to other components, such as image source 229, floating plane 231, depth sensing camera 233, etc., using one or more adjustment devices, such as a rotary encoder (“rotator”) in hinge, a micro-electro-mechanical system (MEMS) tilt sensor, a position tilt sensor/adjustor, etc., attached on imaging plate 227 to achieve the best viewing point for the user as illustrated with respect to FIGS. 3C.

Similarly, in some embodiments, as illustrated with respect to FIG. 3D, one or more adjustment devices may further include infrared (IR) visible markers which may be attached to imaging plate 227 which may then be used for detection and monitoring of positions and tilt angles of imaging plate 227 with respect to image source 229 and floating plane 231, etc., as facilitated by prediction/adjustment logic 205 and as further facilitated by depth sensing camera 233 and depth sensing logic 207 to achieve the best viewing point for the user.

In one embodiment, one or more adjustment devices may be further used by depth sensing logic 207 and/or self-alignment and output calibration logic 209, where depth sensing camera 223 may be used by depth sensing logic 207 to determine output coordinates and calibrate the coordinates upon the user's best viewing point. For example, calibration factor may be determined by a position (e.g., tilt angle) of image plate 227 as facilitated by prediction/adjustment logic 205, where this position may then be used to place the user for best viewing by measuring, for example, the user's height, sitting height, hand/palm placement, finger placement, etc., and applying the measurements to adjust any number and type of components, such as image source 229, floating plane 231, etc., to properly obtain the image source contents, such as the selected image, and place them to produce a virtual representation that floats in mid-air and is capable of being interactive with the user.

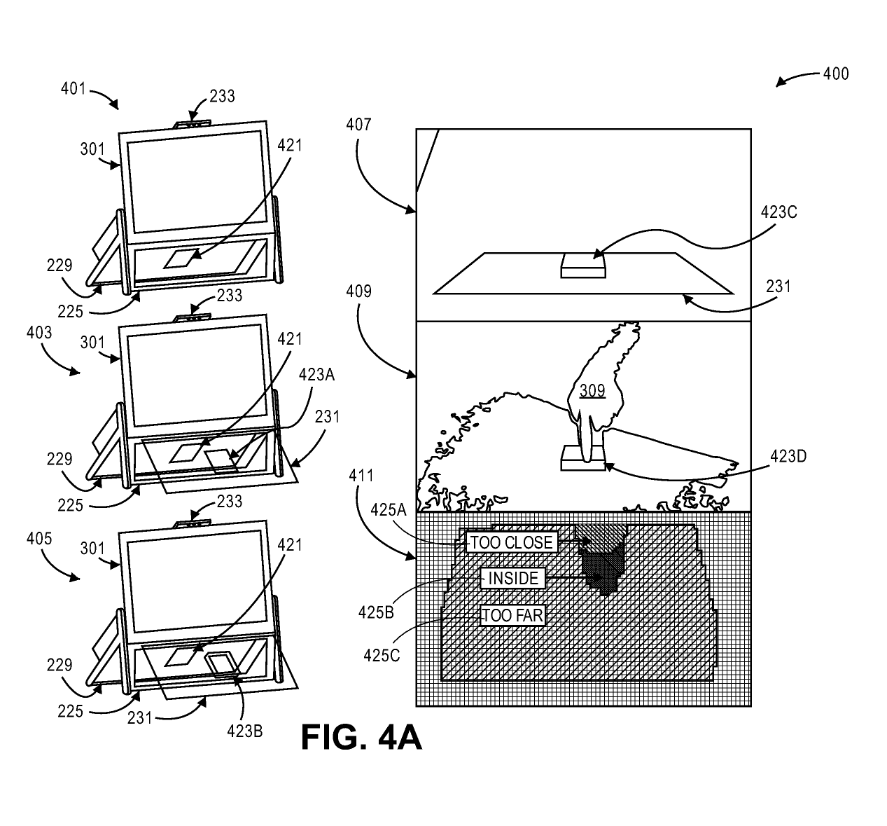

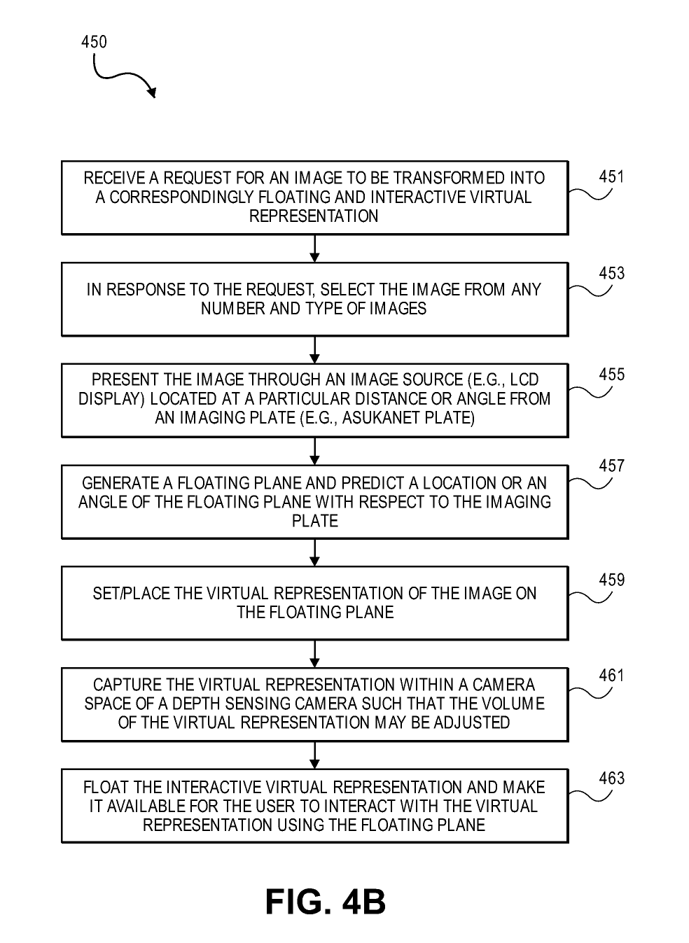

In one embodiment, as illustrated with respect to FIG. 4A, the virtual representation of the selected image (e.g., musical keyboard) may be provided using floating plane 231 such that the virtual representation of the selected image is placed at a reflected location on floating plane 231, wherein the position or angle of floating plane 231 and the reflected location of the virtual representation may be predicted by prediction/adjustment logic 205.

Once the virtual representation is reflected on floating plane 231, the volume location of the virtual representation may be transformed into and presented in a space, referred to as “camera space”, as captured by depth sensing camera 233 and facilitated by depth sensing logic 207. Further, in one embodiment, depth sensing logic 207 may be used to define the minimum depth values and/or maximum depth values for each pixel of any number and type of pixels falling inside the volume of the virtual representation. For example, in case of the musical keyboard, the minimum and maximum depth values of each key of any number and type of keys of the musical keyboard may be depth sensed by depth sensing logic 207.

Further, in one embodiment and as illustrated with respect to FIG. 4A, a per-frame depth map of the pixels may be checked by depth sensing logic 207 by performing a comparison operation, such as performing a simple form of comparison using greater than (the minimum depth) and less than (the maximum depth) components. This comparison operation, in one embodiment, allows for detecting the depth in pixels of the virtual representation of the image, such as the depth to which a human finger can press or penetrate each key of the musical keyboard, while maintaining the virtual representation of the image on floating plane 231 and within the visual space of depth sensing camera 233 from the best viewing point of the viewing user.

For example, if the number of depth pixels needing to satisfy the comparison operation, when counted, exceeds or falls short or equals a predefined threshold, one or more functions associated with the virtual representation may be triggered. It is contemplated that embodiments are not limited to any particular threshold and that any number and type of functions may be triggered upon surpassing, falling short, and/or equaling the threshold.

In one embodiment, once prediction/adjustment of floating plane 231, depth sensing of the virtual representation, and/or self-alignment and calibration of the user based on the user's characteristics (e.g., height, sitting height, positioning of hands, fingers, etc.) is performed, execution/presentation logic 211 is triggered to facilitate presentation of a complete 3D virtual representation of the selected image on floating plane 231 such that the 3D virtual representation may appear to float in air at the right angle and position for the user to not only view the virtual representation but also interact with it, such as play (e.g., touch, press, release, etc.) the keys of the musical keyboard using the virtual representation of the selected image, where the playing may appear as realistic as playing a real-life 3D musical keyboard.

Communication/compatibility logic 213 may be used to facilitate dynamic communication and compatibility between computing device 100 and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “holographic displays”, “floating real image”, “virtual representation”, “depth sensing”, “image source”, “imaging plate” or “Asukanet plate”, “floating plane”, “filtering” or “selecting”, “participating device”, “personal device”, “smart device”, “mobile computer”, “wearable device”, etc., should not be read to limit embodiments to software or devices that carry that label in products or in literature external to this document.

It is contemplated that any number and type of components may be added to and/or removed from floating mechanism 110 to facilitate various embodiments including adding, removing, and/or enhancing certain features. For brevity, clarity, and ease of understanding of floating mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates an architectural setup of computing device 100 according to one embodiment. As an initial matter, for brevity, clarity, and ease of understanding, many of the components and processes discussed above with reference to FIGS. 1-2 may not be repeated or discussed hereafter. It is contemplated that embodiments are not limited to the illustrated architectural setup or the type of computing device 100 as further illustrated in the subsequent Figures.

In one embodiment, computing device 100 may include an all-in-one PC having one or more components along with hosting floating mechanism 110 to perform one or more tasks to transform images, graphics, video, etc., of any one or more number and type of real-life objects into their corresponding virtual representations that are floatable in mid-air and interactive with the user. As illustrated, in some embodiments, computing device 100 may include depth sensing camera 233 placed at the top of main display 301, where computing device 100 may further include an adjustment device (e.g., position tilt sensor/adjuster 303), image source 229, imaging plate 225, and floating plane 231.

FIG. 3B illustrates an architectural setup of computing device 100 according to one embodiment. As an initial matter, for brevity, clarity, and ease of understanding, many of the components and processes discussed above with reference to FIGS. 1-3A may not be repeated or discussed hereafter. It is contemplated that embodiments are not limited to the illustrated architectural setup or the type of computing device 100 as further illustrated in the subsequent Figures.

For example, in one embodiment, in FIG. 3A, depth sensing camera 233 is shown as placed at the top of main display 301; while, in another embodiment, as illustrated here in FIG. 3B, depth sensing camera 233 is placed at the bottom of computing device 100 which further includes image source 229, imaging plate 225, and floating plane 231. As previously described with reference to FIG. 2, various measurements relating to user 305 are performed to reach self-alignment and output calibration for user 305 with respect to floating plane 231 based on and considering any number and type of user characteristics, such as arm length 307 of user 305 stretching from the shoulders of user 305 to the finger points of user 305 at an appropriate point in reference with floating plane 231 and/or the virtual representation being projected through floating plane 231.

FIG. 3C illustrates an architectural setup of computing device 100 according to one embodiment. As an initial matter, for brevity, clarity, and ease of understanding, many of the components and processes discussed above with reference to FIGS. 1-3B may not be repeated or discussed hereafter. It is contemplated that embodiments are not limited to the illustrated architectural setup or the type of computing device 100 as further illustrated in the subsequent Figures.

In the illustrated embodiment, computing device 100 may include an adjustment device/mechanism, such as position tilt sensor/adjustor 303, which may include a rotator, a knob, etc., to help predict/adjust tilt angle of imaging plate 225 with respect to other components, such as image source 229, floating plane 231, etc., as facilitated by depth sensing camera 233 and depth sensing logic 207 of FIG. 2 for performing adjustments (e.g., volume adjustment, depth adjustment, distance/proximity adjustment, etc.) and calibrating output coordinates based on the adjustments for achieving best viewing point 313 for the user to be able to view any virtual representations of images being presented through floating plane 231. For example, best viewing point 313 may result from achieving a coordinated distance between the user's eyes 311 and fingers/palm/hand 309, as detected by depth sensing camera 233, with respect to floating plane 231 so that any image contents of one or more images provided by image source 229 may be dynamically modified or adjusted accordingly and presented to floating plane 231 for their corresponding floating/interactive virtual representations.

FIG. 3D illustrates an architectural setup of computing device 100 according to one embodiment. As an initial matter, for brevity, clarity, and ease of understanding, many of the components and processes discussed above with reference to FIGS. 1-3C may not be repeated or discussed hereafter. It is contemplated that embodiments are not limited to the illustrated architectural setup or the type of computing device 100 as further illustrated in the subsequent Figures.

The illustrated embodiment includes computing device 100 having imaging plate 225 with another type of adjustment device/mechanism that includes IR visible markers 323 attached to imaging plate 225, where depth sensing camera 233 uses IR visible markers 323 and performs relevant calculations for monitoring marker positions and extracting tilt angles of imaging plate 225. As previously discussed with respect to FIG. 3C, the tilting and positioning of imaging plate 225 may be used to achieve best viewing point 313 for the user by coordinating a proper distance between the user's eyes 311 and fingers/hand 309 with respect to floating plane 231.

FIG. 3E illustrates an architectural setup of computing device 100 according to one embodiment. As an initial matter, for brevity, clarity, and ease of understanding, many of the components and processes discussed above with reference to FIGS. 1-3D may not be repeated or discussed hereafter. It is contemplated that embodiments are not limited to the illustrated architectural setup or the type of computing device 100 as further illustrated in the subsequent Figures.

In one embodiment, computing device 100 may include a mobile computer, such as a tablet computer, having a pop-up floating plane (providing notifications, user guidance, etc.) to offer floating images 325, such as the illustrated floating icons, having interactive capabilities that may have a serious utility or be used for fun or simple novelty. These floating virtual representations 325 may be of any form and size, such as 8.9 mm, 10 mm, 11.3 mm, etc., to best suit the various sizes of tablet computers, smartphones, etc., such as computing device 100, and the utility and ease for the user. Accordingly, in some embodiments, the various sizes of virtual representations 325 may be dynamically changed, as desired or necessitated. It is further contemplated that when computing device 100 includes a table computer, as opposed to an all-in-one PC of FIG. 3A, various implementation changes may be taken into account due to a typical tablet computer's form factor constraints (e.g., thinner or smaller designs, bigger or thicker designs, etc.), such as Google® Nexus® 7 (2013) is merely 8.65 cm thick and, as illustrated with respect to FIGS. 3F-3G, a line-symmetric architectural setup of various components may be offered to comply with the design constraints.

Referring now to FIG. 3F and continuing with computing device 100 being a mobile device, such as a tablet computer, a smartphone, a laptop, etc., in a cross-sectional side view, it illustrates a line-symmetric architectural setup where image source 229 and floating plane 231 are line-symmetric with respect to imaging plate 225 within a limited thickness, such as about 8 cm thickness, of the cabinet or housing of computing device 100 being a tablet computer. Further, floating images 325 of FIG. 3E may float over floating plane 231 which may be of varying height based on the various features and specifications of computing device 100, such as tablet thickness (e.g., 8 cm), and where the size of the vertical floating virtual representation may be somewhat higher (e.g., 11.3 mm) compared to the thickness of the tablet computer, such as computing device 100.

FIG. 3G illustrates a cross-sectional side view of a line-symmetric architectural setup of computing device 100, where computing device 100 is a tablet computer. In the illustrated embodiment, to achieve varying sizes of floating virtual representations, such as floating virtual representations 325 of FIG. 3E, an additional optical element, such as prism 327, may be added to the architectural setup. For example, prism 327 may be inserted between imaging plate 225 and image source 229 (e.g., LCD panel), where both imaging plate 225 and image source 229 may be made of glass having a refractive index, such as refractive index of ˜1.52, where prism 327 may also have the same refractive index and be attached by the same refractive index adhesive to eliminate any optical gap in the final virtual representation via floating plane 231. For example, in one embodiment, if virtual representations 325 of FIG. 3E are to be maintained at a certain angle, such as 45 degrees, then image source 229 may be placed at a sufficient angle, such as 34 degrees, from imaging plate 225. In some embodiments, image source 229 may be bigger, such as 14.3 mm, to achieve bigger floating virtual representations, such as 16.97 mm, for better user experience.

FIG. 311 illustrates an architectural setup of an image source 229, an imaging plate 225, and a floating plane 231 according to one embodiment. As illustrated here and discussed above, image source 229 may be at a certain distance or angle, such as first angle θ 331 (e.g., glass angle), from imaging plate 225 which is at a certain distance or angle, such as second angle θ 333 (e.g., floating angle), from floating plane 231. In one embodiment, first angle 331 may be the same as second angle 333, while, in another embodiment, first angel 331 and second angle 333 are not the same and may be adjusted to achieve, for example, varying sizes of virtual representations. It is further illustrated that the glass, such as that of imaging plate 225, may be a grid of corner reflectors, where the light emitted from each pixel may be reflected by imaging plate 225 in a manner that it converges to a properly-located virtual pixel.

Further, for example, a virtual representation may not be flipped left/right or top/bottom and that it may simply be reflected through floating plane 231 of imaging plate 225 such that the image reflected by imaging source 229 may be inverted twice, such as once by glass reflection and once by moving the view point, such as viewer location 341, of the user to a location behind floating plane 231. The net effect to the user may be that the virtual representation appears as though the image of image source 229 has been rotated through an angle of 2θ (such as first angle 331 and second angle 333) until or upon reaching the user.

FIG. 4A illustrates a transaction sequence 400 for facilitating floating interactive virtual representations of images according to one embodiment. As an initial matter, for brevity, clarity, and ease of understanding, many of the components and processes discussed above with reference to FIGS. 1-311 may not be repeated or discussed hereafter. Transaction sequence 400 may be performed by processing logic that may comprise hardware (e.g., circuitry, dedicated logic, programmable logic, etc.), software (such as instructions run on a processing device), or a combination thereof, such as, in one embodiment, transaction sequence 400 may be performed by floating mechanism 110 of FIGS. 1-2. The processes of transaction sequence 400 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

As illustrated, at 401, in one embodiment, computing device 100 may include an all-in-one PC having one or more of the aforementioned components, such as main display 301, depth sensing camera 233, image source 229, imaging plate 225, etc. It is to be noted that as an example, an image, such as image 421, is shown as being on or emitted by image source 229. Let us suppose image 421 is a square touchable hotspot or a clickable link, such as a key of a keyboard, etc. In one embodiment, image 421 may be selected by selection/filtering logic 203 in response to a user request received at detection/reception logic 201 of FIG. 2.

At 403, the known glass angle between image source 229 and imaging plate 225 may be used by prediction/adjustment logic 205 to predict the floating angle between imaging plate 225 and floating plane 231 which may be used to further predict and/or adjust an actual position of floating plane 231 and thus a reflected location of virtual representation 423A in mid-air, where virtual representation 423A being reflected on floating plane 231 is, at this point, a 2D virtual representation of image 421 being shown through image source 229. In one embodiment, prediction/adjustment logic 205 of FIG. 2 may be used to generate floating plane 231 and place it in its predicted reflected location corresponding to imaging plate 225 and based on the user's characteristics and features to provide the user with the best viewing point as facilitated by depth sensing logic 207 and self-alignment and output calibration logic 209 of FIG. 2.

At 405, 2D virtual representation 423A is enhanced into 3D virtual representation 423B of the original image 421, where 3D virtual representation 423B is being presented above and/or below floating plane 231 as facilitated by depth sensing logic 207 of FIG. 2. At 407, a view from depth sensing camera 233 is shown which represents “camera space” within which the volume of virtual representation 423C is adjusted within the defined limits of minimum and maximum depth values for each pixel of virtual representation 423C that would call inside the volume of virtual representation 423C.

At 409, per frame, the depth map in the pixels of virtual representation 423D is checked and determined to perform a simple compare operation representing the depth data within virtual representation 423D which depth sensing camera 233 captures as facilitated by depth sensing logic 207. Further, in one embodiment, at 411, depth pixels needing to satisfy the compare operation are counted and if their number exceeds (or equals or falls short of) a predefined threshold, then one or more functions associated with virtual representation 423C are triggered. For example, the depth pixels, when compared with the predefined threshold, may reveal how deep the user's touch has penetrated into virtual representation 423D with respect to the surrounding surface and whether this much penetration is acceptable or not using various limits, such as too close 425A, inside or sufficiently deep 425B, too far 425D, etc.

FIG. 4B illustrates a method 450 for facilitating floating interactive virtual representations of images according to one embodiment. As an initial matter, for brevity, clarity, and ease of understanding, many of the components and processes discussed above with reference to FIGS. 1-4A may not be repeated or discussed hereafter. Method 450 may be performed by processing logic that may comprise hardware (e.g., circuitry, dedicated logic, programmable logic, etc.), software (such as instructions run on a processing device), or a combination thereof, such as, in one embodiment, method 450 may be performed by floating mechanism 110 of FIGS. 1-2. The processes of method 450 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 450 begins at block 451 with receiving a request for an image to be transformed into a correspondingly floating and interactive virtual representation. At block 453, in response to the request, the image is selected from any number and type of images. At block 455, the image may be presented through an image source (e.g., LDC display) located at a particular distance or angle from an imaging plate (e.g. Asukanet plate) such that using its location and distance, a floating plane may be generated and whose location or angle from the imaging plate may be predicted at block 457.

At block 459, a virtual representation of the image is then set on the floating plane. At block 461, the virtual representation is captured within the camera space of a depth sensing camera such that the volume of the virtual representation may be adjusted (e.g., increased, decreased, etc.), as desired or necessitated, for a realistic 3D presentation that is interactive. At block 463, this interactive virtual representation is floated and made available for the user to use and interact using the floating plane.

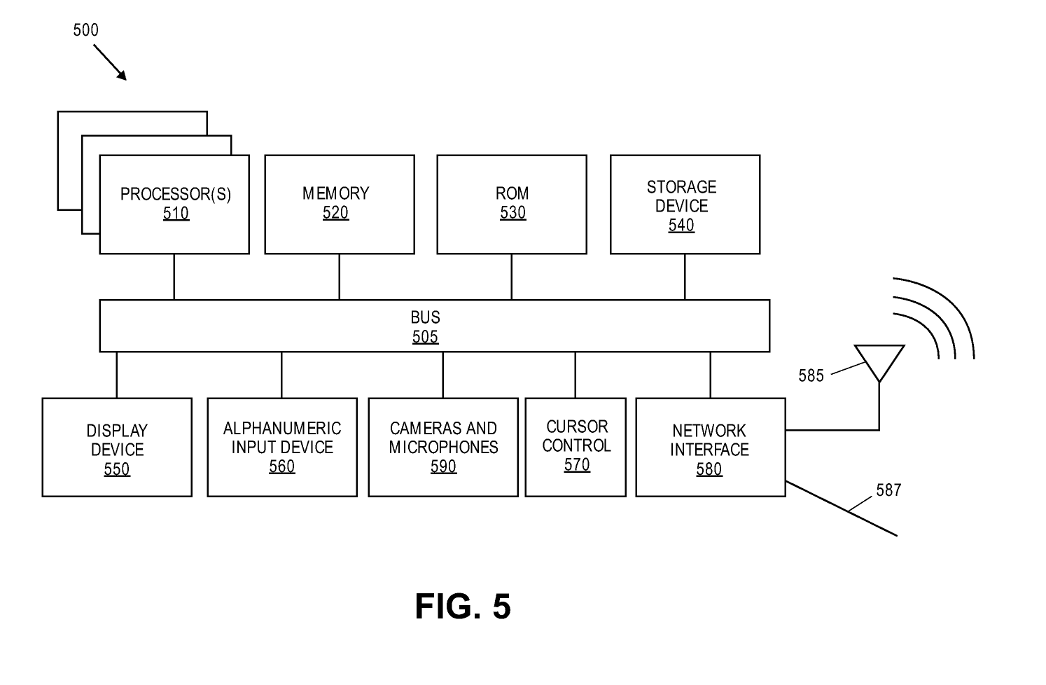

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

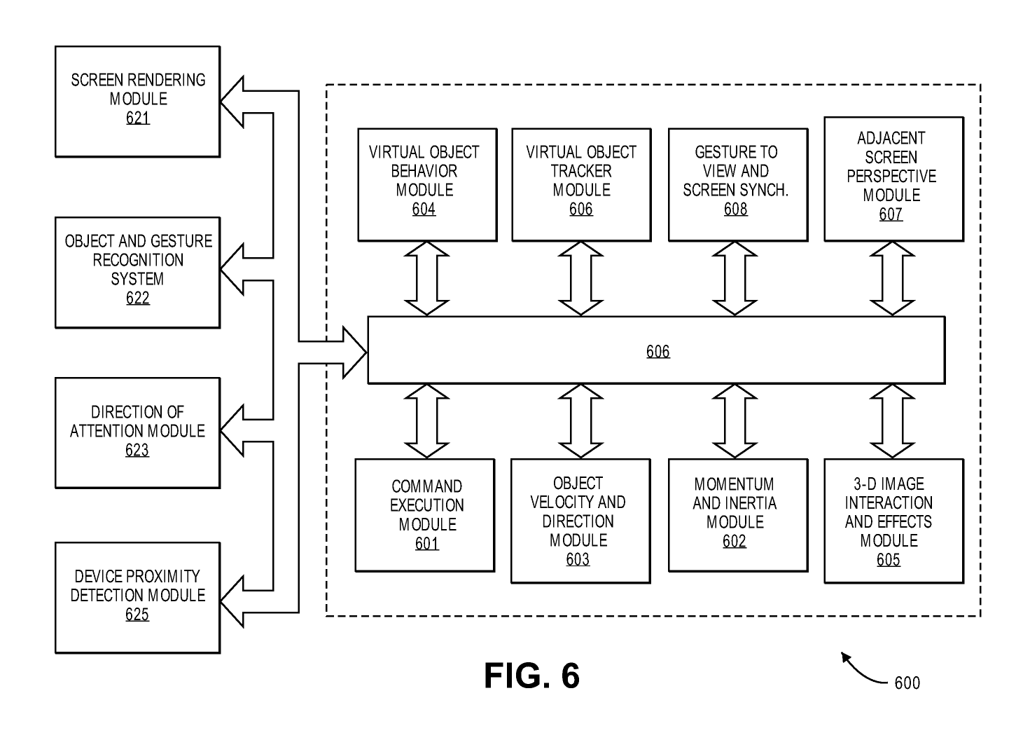

FIG. 6 illustrates an embodiment of a computing environment 600 capable of supporting the operations discussed above. The modules and systems can be implemented in a variety of different hardware architectures and form factors including that shown in FIG. 4.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three dimensional space in a vicinity of an display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate interactive floating virtual representations of images at computing devices, comprising: detection/reception logic to receive a request for a virtual representation of an image of a plurality of images, wherein the virtual representation includes a three-dimensional (3D) virtual representation that is capable of being floated in mid-air; selection/filtering logic to select the image to be presented via an image source located at a first angle from an imaging plate; prediction/adjustment logic to predict a floating plane to be located at a second angle from the imaging plate, wherein the image is communicated from the image source to the floating plane via the imaging plate; and execution/presentation logic to present the virtual representation of the image via the floating plane.

Example 2 includes the subject matter of Example 1, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

Example 3 includes the subject matter of Example 1, further comprising depth sensing logic to compute a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

Example 4 includes the subject matter of Example 1 or 3, further comprising self-alignment and output calibration logic to align and calibrate the virtual representation based on the one or more physical attributes of the user, wherein the one or more physical attributes comprise at least one of a height, a seating height, a view point, and an arm length, wherein the alignment and calibration facilitate a viewing point for the user.

Example 5 includes the subject matter of Example 4, further comprising an adjustment device to facilitate tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

Example 6 includes the subject matter of Example 1 or 5, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

Example 7 includes the subject matter of Example 1, further comprising communication/compatibility logic to facilitate communication between one or more of the image source, the imaging plate, and the floating plane, wherein the image source includes a liquid-crystal-display (LCD) screen, and the imaging plate includes an Asukanet imaging plate.

Example 8 includes the subject matter of Example 1, further comprising a prism between the image source and the imaging plate to serve as an optical element to eliminate optical gaps.

Some embodiments pertain to Example 9 that includes a method for facilitating interactive floating virtual representations of images at computing devices, comprising: receiving a request for a virtual representation of an image of a plurality of images, wherein the virtual representation includes a three-dimensional (3D) virtual representation that is capable of being floated in mid-air; selecting the image to be presented via an image source located at a first angle from an imaging plate; predicting a floating plane to be located at a second angle from the imaging plate, wherein the image is communicated from the image source to the floating plane via the imaging plate; and presenting the virtual representation of the image via the floating plane.

Example 10 includes the subject matter of Example 9, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

Example 11 includes the subject matter of Example 9, further comprising computing a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

Example 12 includes the subject matter of Example 9 or 11, further comprising aligning and calibrating the virtual representation based on the one or more physical attributes of the user, wherein the one or more physical attributes comprise at least one of a height, a seating height, a view point, and an arm length, wherein the alignment and calibration facilitate a viewing point for the user.

Example 13 includes the subject matter of Example 12, further comprising facilitating tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

Example 14 includes the subject matter of Example 12 or 13, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

Example 15 includes the subject matter of Example 9, further comprising facilitating communication between one or more of the image source, the imaging plate, and the floating plane, wherein the image source includes a liquid-crystal-display (LCD) screen, and the imaging plate includes an Asukanet imaging plate.

Example 16 includes the subject matter of Example 9, further comprising placing a prism between the image source and the imaging plate for serving as an optical element to eliminate optical gaps.

Example 17 includes at least one machine-readable medium comprising a plurality of instructions, when executed on a computing device, to implement or perform a method or realize an apparatus as claimed in any preceding claims or examples.

Example 18 includes at least one non-transitory or tangible machine-readable medium comprising a plurality of instructions, when executed on a computing device, to implement or perform a method or realize an apparatus as claimed in any preceding claims or examples.

Example 19 includes a system comprising a mechanism to implement or perform a method or realize an apparatus as claimed in any preceding claims or examples.

Example 20 includes an apparatus comprising means to perform a method as claimed in any preceding claims or examples.

Example 21 includes a computing device arranged to implement or perform a method or realize an apparatus as claimed in any preceding claims or examples.

Example 22 includes a communications device arranged to implement or perform a method or realize an apparatus as claimed in any preceding claims or examples.

Some embodiments pertain to Example 23 includes a system comprising a storage device having instructions, and a processor to execute the instructions to facilitate a mechanism to perform operations comprising: receiving a request for a virtual representation of an image of a plurality of images, wherein the virtual representation includes a three-dimensional (3D) virtual representation that is capable of being floated in mid-air; selecting the image to be presented via an image source located at a first angle from an imaging plate; predicting a floating plane to be located at a second angle from the imaging plate, wherein the image is communicated from the image source to the floating plane via the imaging plate; and presenting the virtual representation of the image via the floating plane.

Example 24 includes the subject matter of Example 23, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

Example 25 includes the subject matter of Example 23, wherein the operations further comprise computing a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

Example 26 includes the subject matter of Example 23 or 25, wherein the operations further comprise aligning and calibrating the virtual representation based on the one or more physical attributes of the user, wherein the one or more physical attributes comprise at least one of a height, a seating height, a view point, and an arm length, wherein the alignment and calibration facilitate a viewing point for the user.

Example 27 includes the subject matter of Example 26, wherein the operations further comprise facilitating tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

Example 28 includes the subject matter of Example 23 or 27, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

Example 29 includes the subject matter of Example 23, wherein the operations further comprise facilitating communication between one or more of the image source, the imaging plate, and the floating plane, wherein the image source includes a liquid-crystal-display (LCD) screen, and the imaging plate includes an Asukanet imaging plate.

Example 30 includes the subject matter of Example 23, wherein the operations further comprise placing a prism between the image source and the imaging plate for serving as an optical element to eliminate optical gaps.

Some embodiments pertain to Example 31 includes an apparatus comprising: means for receiving a request for a virtual representation of an image of a plurality of images, wherein the virtual representation includes a three-dimensional (3D) virtual representation that is capable of being floated in mid-air; means for selecting the image to be presented via an image source located at a first angle from an imaging plate; means for predicting a floating plane to be located at a second angle from the imaging plate, wherein the image is communicated from the image source to the floating plane via the imaging plate; and means for presenting the virtual representation of the image via the floating plane.

Example 32 includes the subject matter of Example 31, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

Example 33 includes the subject matter of Example 31, further comprising means for computing a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

Example 34 includes the subject matter of Example 31 or 33, further comprising means for aligning and calibrating the virtual representation based on the one or more physical attributes of the user, wherein the one or more physical attributes comprise at least one of a height, a seating height, a view point, and an arm length, wherein the alignment and calibration facilitate a viewing point for the user.

Example 35 includes the subject matter of Example 34, further comprising means for facilitating tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

Example 36 includes the subject matter of Example 31 or 35, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

Example 37 includes the subject matter of Example 31, further comprising means for facilitating communication between one or more of the image source, the imaging plate, and the floating plane, wherein the image source includes a liquid-crystal-display (LCD) screen, and the imaging plate includes an Asukanet imaging plate.

Example 38 includes the subject matter of Example 31, further comprising means for placing a prism between the image source and the imaging plate for serving as an optical element to eliminate optical gaps.

Example 39 includes at least one non-transitory or tangible machine-readable medium comprising a plurality of instructions, when executed on a computing device, to implement or perform a method as claimed in any of claims or examples 9-16.

Example 40 includes at least one machine-readable medium comprising a plurality of instructions, when executed on a computing device, to implement or perform a method as claimed in any of claims or examples 9-16.

Example 41 includes a system comprising a mechanism to implement or perform a method as claimed in any of claims or examples 9-16.

Example 42 includes an apparatus comprising means for performing a method as claimed in any of claims or examples 9-16.

Example 43 includes a computing device arranged to implement or perform a method as claimed in any of claims or examples 9-16.

Example 44 includes a communications device arranged to implement or perform a method as claimed in any of claims or examples 9-16.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/reception logic to receive a request for a virtual representation of an image of a plurality of images, wherein the virtual representation includes a three-dimensional (3D) virtual representation that is capable of being floated in mid-air;
selection/filtering logic to select the image to be presented via an image source located at a first angle from an imaging plate;
prediction/adjustment logic to predict a floating plane to be located at a second angle from the imaging plate, wherein the image is communicated from the image source to the floating plane via the imaging plate; and
execution/presentation logic to present the virtual representation of the image via the floating plane.

2. The apparatus of claim 1, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

3. The apparatus of claim 1, further comprising depth sensing logic to compute a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

4. The apparatus of claim 1, further comprising self-alignment and output calibration logic to align and calibrate the virtual representation based on the one or more physical attributes of the user, wherein the one or more physical attributes comprise at least one of a height, a seating height, a view point, and an arm length, wherein the alignment and calibration facilitate a viewing point for the user.

5. The apparatus of claim 4, further comprising an adjustment device to facilitate tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

6. The apparatus of claim 5, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

7. The apparatus of claim 1, further comprising communication/compatibility logic to facilitate communication between one or more of the image source, the imaging plate, and the floating plane, wherein the image source includes a liquid-crystal-display (LCD) screen, and the imaging plate includes an Asukanet imaging plate.

8. The apparatus of claim 1, further comprising a prism between the image source and the imaging plate to serve as an optical element to eliminate optical gaps.

9. A method comprising:
receiving a request for a virtual representation of an image of a plurality of images, wherein the virtual representation includes a three-dimensional (3D) virtual representation that is capable of being floated in mid-air;
selecting the image to be presented via an image source located at a first angle from an imaging plate;
predicting a floating plane to be located at a second angle from the imaging plate, wherein the image is communicated from the image source to the floating plane via the imaging plate; and
presenting the virtual representation of the image via the floating plane.

10. The method of claim 9, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

11. The method of claim 9, further comprising computing a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

12. The method of claim 9, further comprising aligning and calibrating the virtual representation based on the one or more physical attributes of the user, wherein the one or more physical attributes comprise at least one of a height, a seating height, a view point, and an arm length, wherein the alignment and calibration facilitate a viewing point for the user.

13. The method of claim 12, further comprising facilitating tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

14. The method of claim 13, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

15. The method of claim 9, further comprising facilitating communication between one or more of the image source, the imaging plate, and the floating plane, wherein the image source includes a liquid-crystal-display (LCD) screen, and the imaging plate includes an Asukanet imaging plate.

16. The method of claim 9, further comprising placing a prism between the image source and the imaging plate for serving as an optical element to eliminate optical gaps.

17. At least one machine-readable medium comprising a plurality of instructions, executed on a computing device, to facilitate the computing device to perform operations comprising:
receiving a request for a virtual representation of an image of a plurality of images, wherein the virtual representation includes a three-dimensional (3D) virtual representation that is capable of being floated in mid-air;
selecting the image to be presented via an image source located at a first angle from an imaging plate;
predicting a floating plane to be located at a second angle from the imaging plate, wherein the image is communicated from the image source to the floating plane via the imaging plate; and
presenting the virtual representation of the image via the floating plane.

18. The machine-readable medium of claim 17, wherein the image originating at the image source is inverted through the first angle and the second angle prior to reaching the floating plane, wherein the second angle is predicted based on one or more of the first angle, a size of the visual representation, one or more physical attributes of a user viewing or interacting with the virtual representation.

19. The machine-readable medium of claim 17, wherein the operations further comprise computing a depth map of a plurality of pixels of the virtual representation, wherein the depth map to provide sufficient volume to the virtual representation to facilitate interactivity of the virtual representation, wherein the interactivity to allow the user to interact, in real-time, with the 3D virtual representation representing the image of a real-life 3D object.

20. The machine-readable medium of claim 17, wherein the operations further comprise aligning and calibrating the virtual representation based on the one or more physical attributes of the user, wherein the one or more physical attributes comprise at least one of a height, a seating height, a view point, and an arm length, wherein the alignment and calibration facilitate a viewing point for the user.

21. The machine-readable medium of claim 20, wherein the operations further comprise facilitating tilting or adjusting of the imaging plate with respect to the image source to place or adjust the floating plane in accordance with the physical attributes of the user to achieve the viewing point, wherein the adjustment device includes a rotator at a hinge or a micro-electro-mechanical (MEMS) tile sensor.

22. The machine-readable medium of claim 21, wherein the adjustment device further comprises one or more of infrared (IR) visible markers at the imaging plate, wherein the IR visible markers are used by a depth sensing camera as facilitated by the depth sensing logic to perform a calculation to extract a tilt angle for the imaging plate to provide the viewing point.

23. The machine-readable medium of claim 17, wherein the operations further comprise facilitating communication between one or more of the image source, the imaging plate, and the floating plane, wherein the image source includes a liquid-crystal-display (LCD) screen, and the imaging plate includes an Asukanet imaging plate.

24. The machine-readable medium of claim 17, wherein the operations further comprise placing a prism between the image source and the imaging plate for serving as an optical element to eliminate optical gaps.
